(19) United States
(12) Patent Application Publication
(10) Pub. No.: US 2015/0347874 A1
(43) Pub. Date: Dec. 3, 2015

(54) PRINTING APPARATUS

(71) Applicant: SEIKO EPSON CORPORATION, Tokyo (JP)

(72) Inventors: Kiyoshi MUKAIYAMA, Matsumoto-shi (JP); Mamoru AKATSU, Matsumoto-shi (JP)

(21) Appl. No.: 14/725,935

(22) Filed: May 29, 2015

(30) Foreign Application Priority Data
May 29, 2014 (JP) 2014-110949
Apr. 23, 2015 (JP) 2015-088165

(51) Int. Cl. G06K 15/00

(52) U.S. Cl. CPC G06K 15/005

(57) ABSTRACT

A printing apparatus includes a storage device and print attribute information from which it is determinable whether or not a file is suitable for printing is displayed on a file list screen on which a file stored in the storage device is selectable.

### BACKGROUND

1. Technical Field

The present invention relates to a printing apparatus.

2. Related Art

Examples of an ink jet printer as a printing apparatus include a single-function printer that specializes in a printing function and a multifunction printer that has multiple image processing functions. For example, JP-A-2007-228035 discloses a multifunction printer that has an image reading function (a scanner) in addition to a printing function (a printer) and is configured to have an image transmitting function (a facsimile) as an option. The multifunction printer includes a communication unit or file transferring unit and a file storage unit and thereby, operations of transferring of information or copying are performed without booting up a computer which is connected to the multifunction printer.

However, the printing apparatus (multifunction printer) disclosed in JP-A-2007-228035 has a problem in that it is not immediately determined whether or not a file stored in the file storage unit is a file suitable for being printed. Specifically, since information displayed in a file list is limited to a file name or reception time in a case of receiving image through a facsimile, a facsimile number, a sender (forwarding source), the number of pages, or the like and does not include information such as resolution of an image or an image size from which it is determined whether or not a file is suitable for printing, each file has to be opened and checked using an image processing application (software) in the printing process.

### SUMMARY

The invention can be realized in the following forms or application examples.

### Application Example 1

According to this application example, there is provided a printing apparatus including: a storage device; and a display section that displays a file list screen on which a file stored in the control device is selectable. Print attribute information, from which suitability of the file for printing is determinable, is displayed on the file list screen.

In this case, the printing apparatus includes the storage device and the display section that displays a file list screen on which a file stored in the storage device is selectable. Therefore, it is possible for a user of the printing apparatus to store the file in the printing apparatus and then to print the file. In addition, it is possible for the user to look at a list of stored files. The print attribute information, from which suitability of the file for printing is determinable, is displayed on the file list screen. Therefore, when an image based on the file is printed, only a look at the file list screen makes it possible for the user to easily determine suitability of the file for printing.

### Application Example 2

In the printing apparatus according to the application example, the print attribute information may be displayed as an icon.

In this case, since the print attribute information is displayed as an icon, only a look at the file list screen makes it possible for the user to more easily determine suitability of the file for printing.

### Application Example 3

In the printing apparatus according to the application example, the print attribute information includes a resolution information of a print image in the file.

In this case, since the print attribute information includes the resolution information of the print image included in the file, only a look at the file list screen makes it possible for the user to more easily determine suitability of the file for printing.

### Application Example 4

In the printing apparatus according to the application example, the print attribute information includes a print history information of the file.

In this case, since the print attribute information includes the print history of the file, only a look at the file list screen makes it possible for the user to more easily select the file as a print target when the image includes in the file is printed.

### Application Example 5

In the printing apparatus according to the application example, the print attribute information includes a size information of a print image in the file.

In this case, since the print attribute information includes the size information of a print image in the file, only a look at the file list screen makes it possible for the user to more easily determine suitability of the file for printing.

### Application Example 6

According to this application example, there is provided a printing apparatus including: a connecting section to which a display terminal is connectable; and a storage device. In the display terminal that displays a file list screen on which a file stored in the storage device is selectable, print attribute information, from which suitability of the file for printing is determinable, is displayed on the file list screen.

In this case, the printing apparatus includes the connecting section to which the display terminal is connectable and the storage device. In addition, in the display terminal that displays the file list screen on which the file stored in the storage device is selectable, the print attribute information based on attributes of the file is displayed on the file list screen. Therefore, it is possible for a user of the printing apparatus to store a file in the printing apparatus and then to print the file. In addition, it is possible for the user to look at a list of stored files. The print attribute information, from which suitability of the file for printing is determinable, is displayed on the file list screen. Therefore, when an image based on the file is printed, only a look at the file list screen makes it possible for the user to easily determine suitability of the file for printing.

### Application Example 7

In the printing apparatus according to the application example, the print attribute information may be displayed as an icon.

In this case, since the print attribute information is displayed as an icon, only a look at the file list screen makes it possible for the user to more easily determine suitability of the file for printing.

### Application Example 8

In the printing apparatus according to the application example, the print attribute information includes a resolution information of a print image in the file.

In this case, since the print attribute information includes the resolution information of the print image in the file, only a look at the file list screen makes it possible for the user to more easily determine suitability of the file for printing.

### Application Example 9

In the printing apparatus according to the application example, the print attribute information may be displayed based on a print history of the file.

In this case, since the print attribute information includes the print history information of the file, only a look at the file list screen makes it possible for the user to more easily select the file as a print target when the image included in the file is printed.

### Application Example 10

In the printing apparatus according to the application example, the print attribute information includes a size information of a print image in the file.

In this case, since the print attribute information is displayed based on the size of the print image included in the file, only a look at the file list screen makes it possible for the user to more easily determine suitability of the file for printing.

### BRIEF DESCRIPTION OF THE DRAWINGS

The invention will be described with reference to the accompanying drawings, wherein like numbers reference like elements.

FIG. 1 is a perspective view of a printer as a printing apparatus according to Embodiment 1.

FIG. 2 is a block diagram of the printer as the printing apparatus according to Embodiment 1.

FIG. 3 is a perspective view of an image acquiring device (scanner unit) as an example of a function expansion device.

FIG. 4 is a conceptual diagram illustrating a hierarchical configuration of a control center.

FIGS. 5A and 5B are conceptual diagrams of start screens which are displayed in a tablet terminal.

FIGS. 6A and 6B are conceptual diagrams of start screens which are displayed in the tablet terminal.

FIG. 7 is a conceptual diagram of an initial screen of the control center which is started.

FIGS. 8A and 8B are conceptual diagrams of icon regions in a case where an HDD unit is not attached.

FIG. 9 is a conceptual diagram of a copy screen.

FIG. 10 is a conceptual diagram of a scan screen.

FIG. 11 is a conceptual diagram of a file operation screen.

FIG. 12 is a conceptual diagram of an operation history display screen.

FIG. 13 is a conceptual diagram of a detailed information screen.

### DESCRIPTION OF EXEMPLARY EMBODIMENTS

Hereinafter, an embodiment of the invention will be described with reference to the drawings. The following description is only an embodiment of the invention, and the invention is not limited thereto. In the following drawings, in order for the description to be easily understandable, there is a case in which a size is different from an actual size. In addition, in a coordinate system in the drawings, a Z axial direction is a vertical direction, a +Z direction is an upward direction, a Y axial direction is a frontward-rearward direction, a +Y direction is a frontward direction, an X axial direction is a horizontal direction, a +X direction is a left direction, and an X-Y plane is a horizontal plane.

### Embodiment 1

### Printing Apparatus

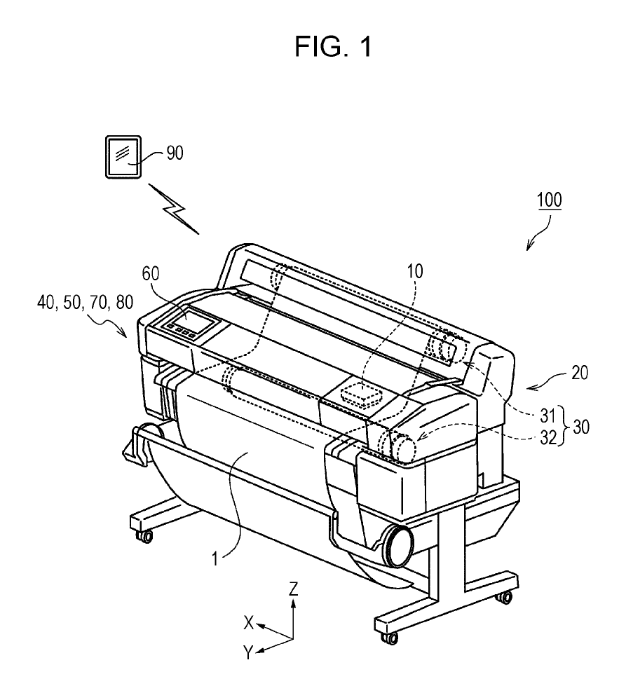

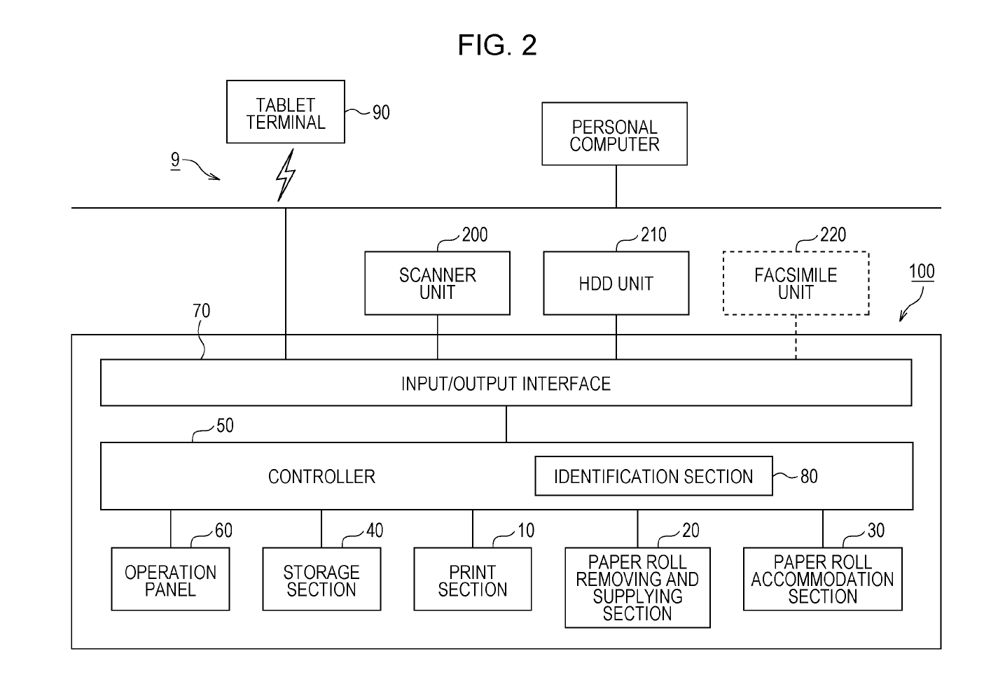

FIG. 1 is a perspective view and FIG. 2 is a block diagram of a printer 100 as a “printing apparatus” according to Embodiment 1.

For example, the printer 100 is a large-sized ink jet type printer which is able to perform printing on a printing medium of a relatively large size such as A0 size or B0 size in JIS standards. The printing medium is supplied in a state of being wound in a roll shape (hereinafter, the printing medium is referred to as a paper roll 1).

The printer 100 is configured to include a print section 10, a paper roll removing and supplying section 20, a paper roll accommodation section 30, a storage section 40, a controller 50, an operation panel 60 as a “display section”, an input/output interface 70 as a connecting section to an external device, an identification section 80, and the like.

In addition, the printer 100 includes a storage device (HDD (hard disk drive) unit 210) as a function expansion device (optional device) and can be configured as a multifunction printer by further attaching a function expansion device. Examples of the function expansion device that is further attached include an image acquiring device (for example, scanner unit 200), an image transferring device (for example, facsimile unit 220), or the like, and the devices can be attached individually and all at the same time and can be configured to perform multi-functions.

The HDD unit 210 is a USB device which is connected to the printer 100 through a USB interface (not illustrated) and has a sufficient storage capacity (for example, capacity that can be used for saving an image file (hereinafter, the image file is simply referred to as a file) obtained by the scanner unit 200).

In addition, it is possible for the printer 100 to be connected to a “display terminal” as a human interface, in addition to the operation panel 60, through a network 9 to which the printer 100 is connected using the input/output interface 70. A tablet terminal 90 is used as a model example of the display terminal but the display terminal is not limited thereto. As long as a Web browser is displayed, a mobile communication terminal or a personal computer may be used as the display terminal.

Wireless LAN is used as a model example of the network 9 but wired LAN or a private dedicated circuit may be used.

The print section 10 includes an ink jet head which discharges ink and prints an image on a surface of the paper roll 1, a carriage which supports the ink jet head and causes the ink jet head to move and scan the surface of the paper roll 1, and the like (not illustrated).

The paper roll removing and supplying section 20 includes a plurality of transport rollers (not illustrated) which supply the paper roll 1 accommodated in the paper roll accommodation section 30 before printing thereon to a scanning movement region of the print section 10 (or return the paper roll 1 to the paper roll accommodation section 30 side from the scanning movement region of the print section 10).

The paper roll accommodation section 30 includes a first accommodation section 31 provided in an upper rear side of an apparatus body and a second accommodation section 32 disposed on the lower side of the apparatus body. The paper rolls 1 before printing may be accommodated in the first accommodation section 31 and the second accommodation section 32, respectively. In addition, different types (material properties, sizes or the like) of paper rolls 1 can be accommodated in the accommodation sections, respectively.

Each of the first accommodation section 31 and the second accommodation section 32 includes a pair of holders which hold the paper roll 1 from both sides in an axial direction thereof and motors (not illustrated) which transmit rotative power to the pair of holders. Driving of the motors causes the paper roll 1 held by the holders to rotate and thereby, the paper roll 1 is unrolled or is rewound as necessary.

The storage section 40 is a rewritable storage medium such as a hard disk drive or a memory card. Software (a program) or the like which causes the controller 50 to operate is stored in the storage section 40.

The controller 50 includes a CPU (operation unit) and a storage unit (not illustrated) such as a RAM, and a ROM and performs centralized control of the entire printer 100 based on the software which causes the controller 50 to operate.

The operation panel 60 includes a display and an input section on which instruction to or selection on the controller 50 can be performed.

The identification section 80 is configured as a functional section of the controller 50 and can recognize connection with a function expansion device and can recognize inherent identification information of the connected function expansion device. Specifically, in a case where the function expansion device is a USB device, each function expansion device has key information such as a vendor ID, a product ID, or a serial number as the inherent identification information. The identification section 80 reads these items of information from a function expansion device connected to the input/output interface 70 and can identify a type or model number, a device number, or the like of the connected function expansion device.

### Function Expansion Device

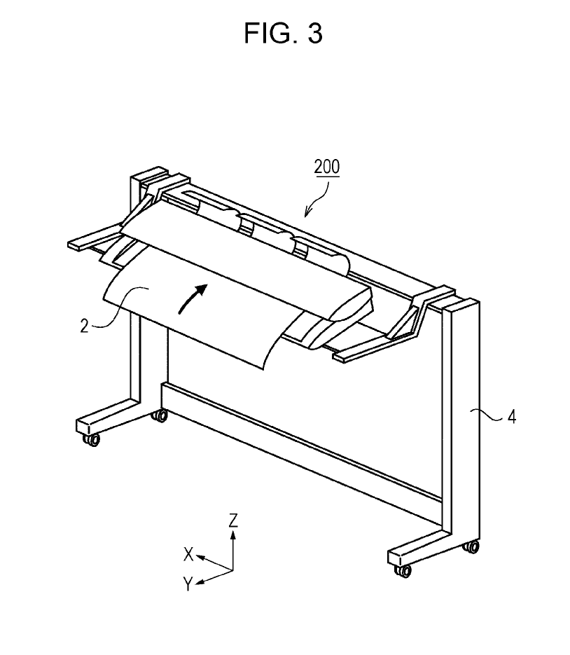

FIG. 3 is a perspective view of the scanner unit 200 as the image acquiring device as an example of a function expansion device.

The scanner unit 200 is a sheet feeding type (reading-head fixing type) image scanner in which an original document (original document 2 in FIG. 3) which has a size up to a relatively large size such as A0 or B0 can be read. The scanner unit 200 includes an original document transport mechanism which removes and supplies the original document 2, an original document reading mechanism (not illustrated) which is configured to have a light source or an image sensor, and the like, and the scanner unit is mounted on a transportable stand 4. The transportable stand 4 can be disposed behind (−Y direction) the printer 100 and supports an undersurface of a body of the scanner unit 200 such that the scanner unit 200 is positioned above the printer 100. In addition, the scanner unit 200 includes, as a USB device, a USB interface which is connected to the printer 100.

A description of a detailed configuration of the scanner unit 200 is omitted.

In a case where the scanner unit 200 is attached to the printer 100, it is possible for the printer 100 to have a copy function to print an image captured by the scanner unit 200.

In addition, since the printer 100 includes the HDD unit 210, it is possible for the printer 100 to have the following functions.

It is possible for the image captured by the scanner unit 200 to be saved as a file such as a JPEG file or a PDF file.

It is possible for the file to be attached to an email and to be sent to another printer 100 or the like.

It is possible for the file to be saved in a shared folder on the network 9 through the network 9.

It is possible for the file to be downloaded or to be received by email.

### Control Center

The printer 100 includes a control center as control software which causes the devices to perform functions thereof. The control center is one of programs which are operated in the controller 50 and controls and causes hardware, software, and firmware which are included in the printer 100 and the scanner unit 200 to perform functions thereof.

In addition, on the basis of a state in which the scanner unit 200 or the HDD unit 210 is connected, the control center causes operational information on these function expansion devices to be displayed on the operation panel 60 or the tablet terminal 90 and thus, it is possible to perform various operations.

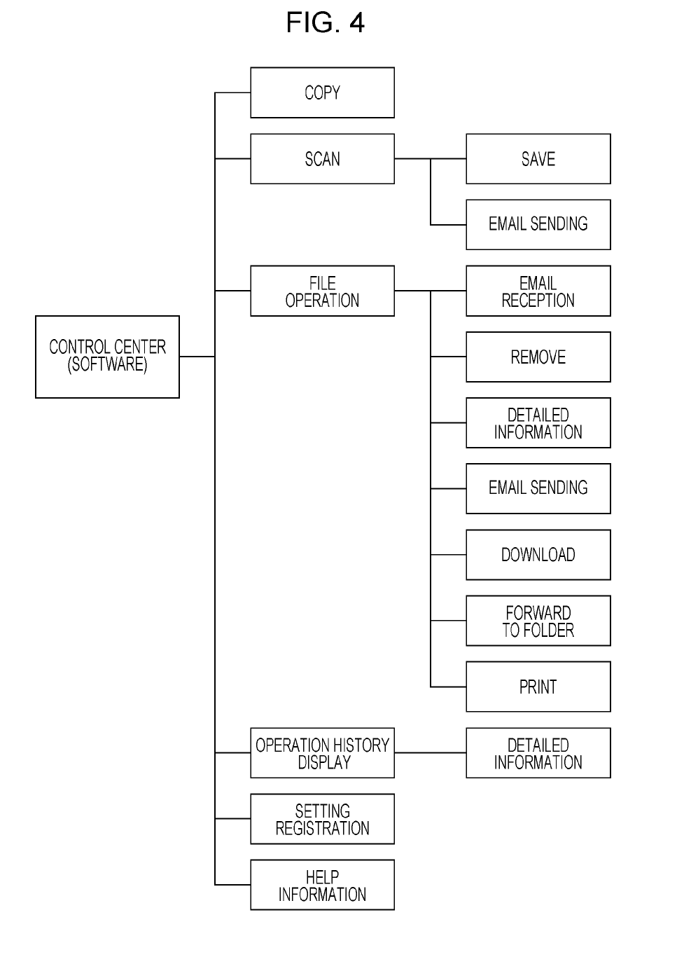

FIG. 4 is a conceptual diagram illustrating a hierarchical configuration of a control center.

The control center has functions such as copying, scanning, file operation, operation history display, setting registration, help information display, and the like.

In this manner, the scanner unit 200 as the function expansion device is attached to the printer 100 and thereby various functions are added. When the various functions are added, operations which correspond to the respective functions, an operation which selects and performs the corresponding function, a display of an operation screen thereof, or the like becomes complicated. In the present embodiment, such operations are more simply performed.

Hereinafter, a description is provided about a start method of the printer 100 or a function of the control center in a case where the scanner unit 200 and the HDD unit 210 are attached to the printer 100, with reference to a screen displayed on the tablet terminal 90.

### Start of Control Center

In a case where the scanner unit 200 is attached to the printer 100, the control center can be started by access to the printer 100 from the tablet terminal 90 through the network 9. Specifically, a Web browser is first started on the tablet terminal 90. Next, an IP address which is set in the printer 100 is input to an address bar of the Web browser and a key of [Enter] or [Return] is pressed.

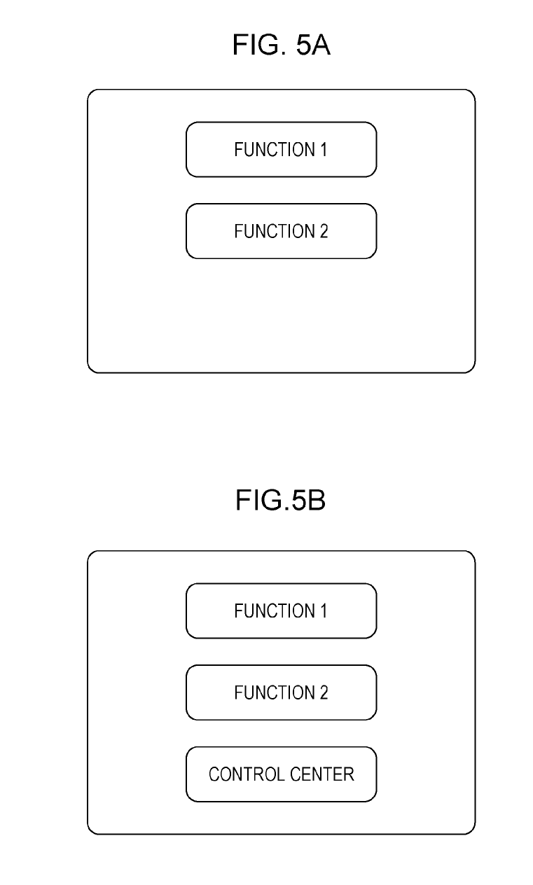

FIG. 5A is a conceptual diagram of a start screen which is displayed in the tablet terminal 90 in a case where the scanner unit 200 is not attached to the printer 100. Since the scanner unit 200 is not attached to the printer, buttons (or icons) are displayed, which can cause only available functions (illustrated as function 1 and function 2 in FIG. 5A) other than the control center to be started.

In contrast, in a case where the scanner unit 200 is attached to the printer 100 or in a case where access from the tablet terminal 90 is performed in a state in which the scanner unit 200 is attached to the printer 100, a button (or an icon) which can cause the control center to be started is also displayed as illustrated in FIG. 5B.

This is because, in a case where the scanner unit 200 is attached to the printer 100, the identification section 80 detects the attachment and the controller 50 which receives the detected result causes the start button (or icon) of the control center to be displayed as an available function.

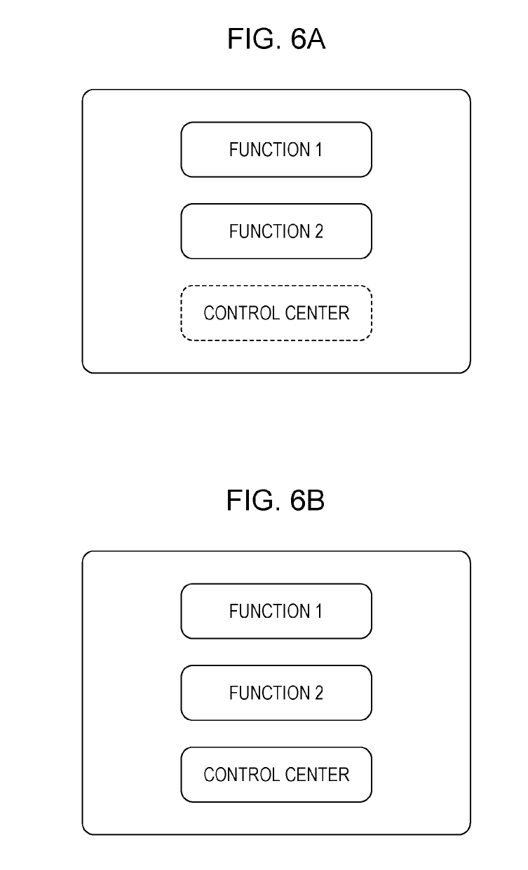

FIG. 5A illustrates that only the buttons (icons) which can cause available functions to be started are displayed, but the display is not limited thereto. Any display may be employed as long as a user who operates the tablet terminal 90 can simply recognize the availability of a function. For example, a method of display may be employed, in which an unavailable function button is grayed out. An example in FIG. 6A shows a state in which a control center start button (icon) is grayed out. The graying-out in light gray is used as a method of showing that the button cannot be selected (shown by a broken line in FIG. 6A). FIG. 6B illustrates a screen of a state in which the control center can be started, similar to in FIG. 5B.

The control center is selected on the screen in FIG. 5B or FIG. 6B and then, the control center is started.

In a case of the access from the tablet terminal 90 in a state in which the scanner unit 200 is attached to the printer 100, the control center is directly started without displaying a screen illustrated in FIG. 5A or 5B or FIG. 6A or 6B in a case where there is no function to be started other than the control center.

In this specification, “to select” an icon or button on a screen of the operation panel 60 or the tablet terminal 90 means that selection by a click or tap of a position of a target icon or button with a pointing device such as a mouse or a user's fingertip is valid. In addition, in a case where options are prepared in advance, selection of a target button causes the prepared options to be displayed as a pull-down menu and selection can be performed.

### Initial Screen

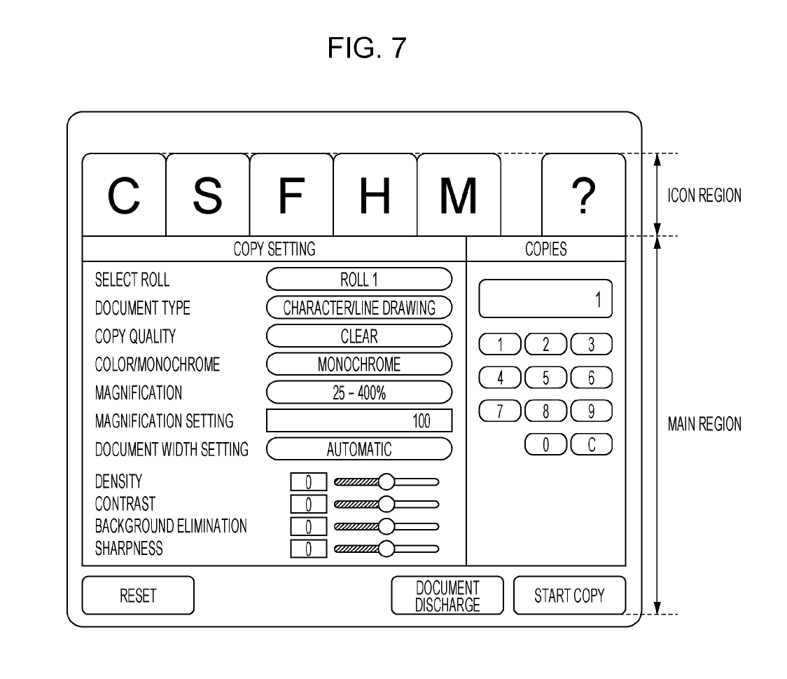

FIG. 7 is a conceptual diagram of an initial screen of the control center which is started.

The initial screen is displayed as being divided into an icon region and a main region. In addition to these regions, a banner region (region in which information which is linked to another Web site is displayed) or a footer region (region which is fixed and displayed under the main region) may be displayed.

In the icon region, icons which enable functions of the control center to be selected are displayed.

Specifically, icons corresponding to respective functions of copy, scan, file operation, operation history display, setting registration, and display of help information, which are described above are displayed. FIG. 7 illustrates respective icons by copy “C”, scan “S”, file operation “F”, operation history display “H”, setting registration “M”, and display of help information “?” and it is desirable that the icons are formed of graphics from which a user can instinctively discern the functions.

As described above, even in a case where the scanner unit 200 is attached, the functions thereof are limited in a case where the HDD unit 210 is not attached. Specifically, in a case where the HDD unit 210 is not attached, only the copy function is the main function since scanned data is not saved and thus, functions of scan “S”, file operation “F”, operation history display “H”, and the like are not available.

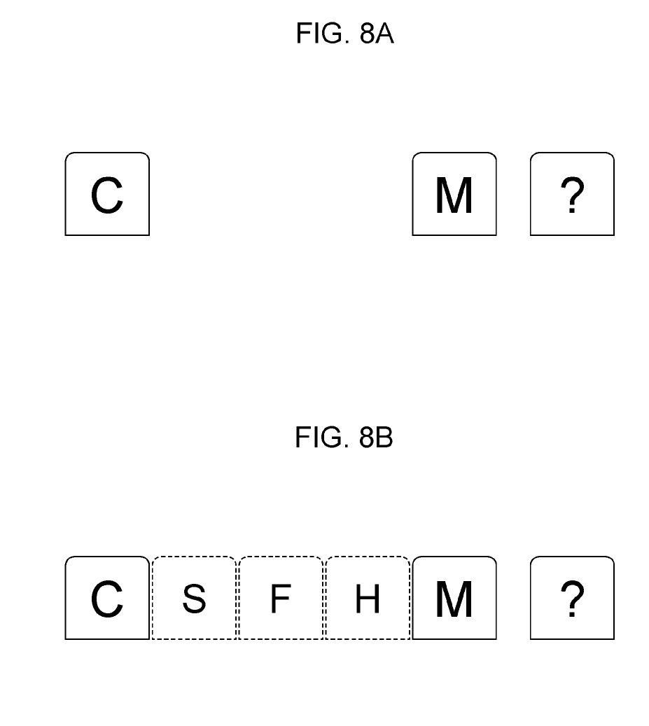

FIGS. 8A and 8B are conceptual diagrams of icons displayed in the icon regions in a case where the HDD unit 210 is not attached.

FIG. 8A illustrates a state in which unavailable icons (scan “S”, file operation “F”, and operation history display “H”) are not displayed.

FIG. 8B illustrates a state in which unavailable icons (scan “S”, file operation “F”, and operation history display “H”) are displayed by being grayed out.

This is how the functions are displayed as not available by the controller 50 because identification section 80 does not detect the attachment (or attaching operation) of the HDD unit 210 to the printer 100.

### Copy Screen

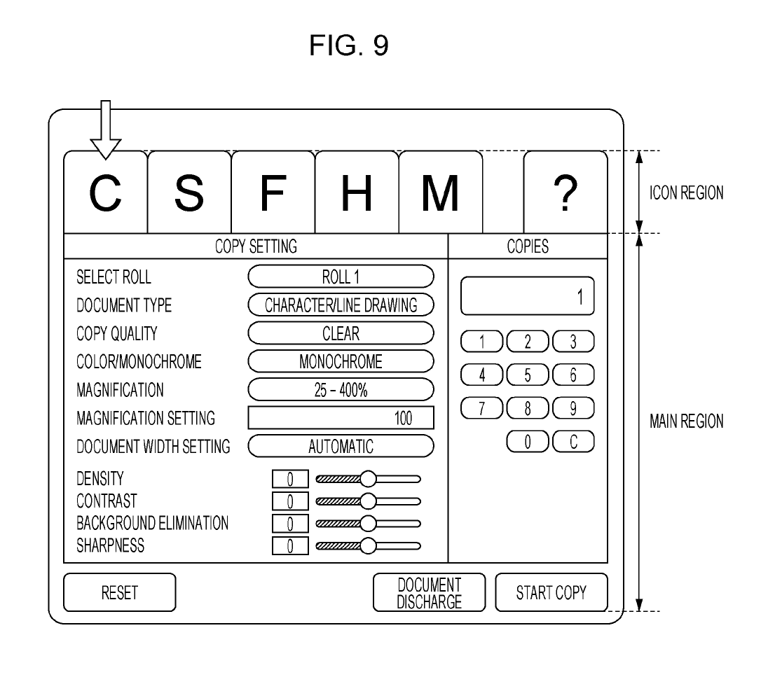

FIG. 9 is a conceptual diagram of a screen (hereinafter, referred to as a copy screen) which is displayed in a case where a copy icon “C” in the icon region is selected. The initial screen (FIG. 7) of the control center which is started may be the same as the copy screen.

A parameter to execute copying can be designated on the copy screen. When the copy screen is opened, the identification section 80 confirms the connection state of the scanner unit 200 and the copy screen is displayed as long as the scanner unit 200 is connected to the printer.

In the drawings, a bold downward arrow indicates that an icon with the arrow is selected but the arrow is not displayed on the screen.

In the main region on the copy screen, only parameters are displayed, for which settings are needed in a case where the copy function is used. On the copy screen, selection of the paper roll 1 (roll section), selection of a type of original document (document type), selection of a print quality (copy quality), selection of color or monochrome (color/monochrome), setting of magnification (magnification and magnification setting), setting of a size of an original document (document width setting), setting of density (density), setting of contrast (contrast), setting of background elimination (background elimination), setting of sharpness (sharpness), designation of the number of copies, and the like can be performed. In addition, there are buttons which enable resetting of setting contents, discharge of the set original document 2, start of copying, or the like to be executed.

### Scan Screen

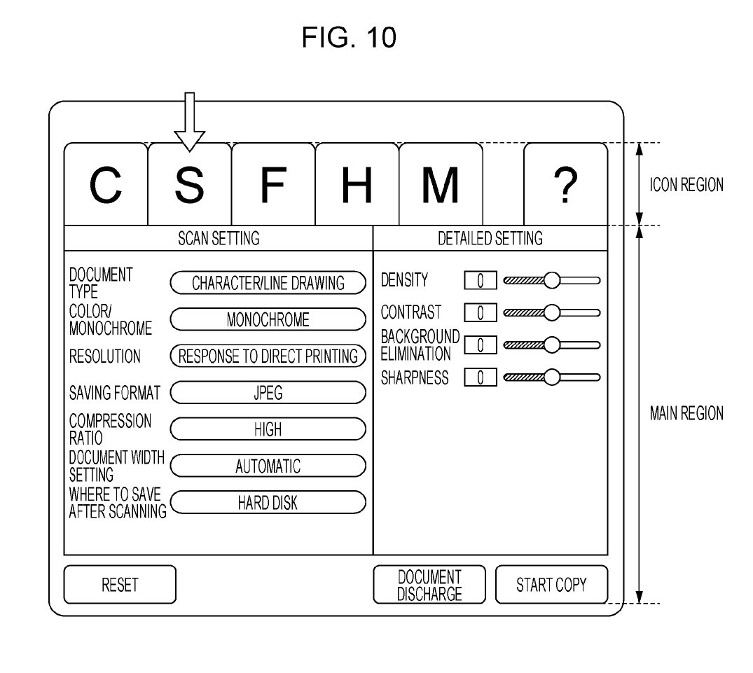

FIG. 10 is a conceptual diagram of a screen (hereinafter, referred to as a scan screen) which is displayed in a case where a scan icon “S” in the icon region is selected.

In the main region on the scan screen, only parameters are displayed, for which settings are needed in a case where the scan function is used.

On the copy screen, selection of the type of the original document 2 (document type), selection of color or monochrome (color/monochrome), selection of resolution at the time of scanning (resolution), selection of a format of saving a file (saving format), selection of a compression ratio (compression ratio), setting of a size of an original document (document width setting), selection of a save location of scan data (save location after scanning), setting of density (density), setting of contrast (contrast), setting of background elimination (background elimination), setting of sharpness (sharpness), and the like can be performed. In addition, there are buttons which enable resetting of setting contents, discharge of the set original document 2, start of scanning, or the like to be executed.

In the selection of resolution (resolution) at the time of scanning, in addition to selecting a value of resolution (for example, 200 dpi or 400 dpi), it is possible to select “corresponding to direct printing” from the pull-down menu. When the “corresponding to direct printing” is selected, an optimal value (optimal resolution set in advance) in a case of printing by the print section 10 is automatically selected. In addition, a file obtained by selecting the “corresponding to direct printing” and scanning is displayed on a file list screen along with an icon corresponding to a “printable file” on a screen which will be described below.

### File Operation Screen

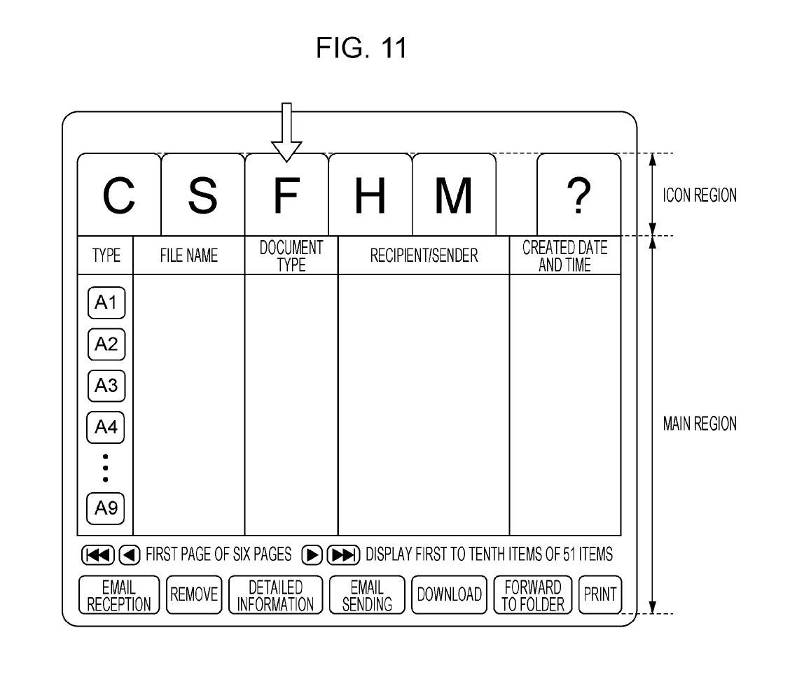

FIG. 11 is a conceptual diagram of a screen (hereinafter, referred to as a file operation screen) which is displayed in a case where a file operation “F” in the icon region is selected.

In the main region on the file operation screen, a file list screen is displayed, on which a file (file created from scanning, file received by email, or the like) stored in the HDD unit 210 can be selected. Items to be displayed include an icon of the type of file (type), file name, document type, sender's email address in a case of receiving email or destination email address in a case of sending email, destination folder name (recipient/sender) in a case of being saved in a shared folder, created date and time, and the like.

In addition, since a list of files may fill a plurality of pages in some cases, there are buttons of next page and previous page or a section in which information on a displayed page is displayed.

In addition, on the file operation screen, there are buttons which enable email reception, removing, displaying detailed information, email sending, downloading, forwarding to folder, printing, or the like to be executed with respect to a file selected from the list of files.

Icons to be displayed in a column of type represent items of print attribute information based on attributes related to printing of a file. The print attribute information includes at least a resolution information, a size information, a print history information, (or/and) the like of print image in file. The corresponding icons (A1 to A9) are displayed based on the resolution information or the size information and the print attribute information such as the print history information or the like of a print image in the file. In addition, the icons are not displayed for a file which is not relevant to the icons (A1 to A9) in which the print attribute information is set.

The icons (A1 to A9) are, for example, as follows. The icons include A1: file saved in the HDD unit 210 after scanning; A2: printable file saved in the HDD unit 210 after scanning; A3: saved file sent by email after scanning; A4: saved printable file sent by email after scanning; A5: file saved in a shared folder after scanning; A6: printable file saved in a shared folder after scanning; A7: file received by email; A8: printable file received by email; and A9: printable file which is received by email and is not yet printed.

Types of icons which represent the items of the print attribute information are not limited thereto and any icon may be used as long as the icon makes it easy to perform selection or recognition in a case where a user selects a target file at the time of printing. For example, for a printable file, icons representing ultra-high-definition, high-definition, normal, or the like corresponding to the resolution of a print image may be provided.

In addition, in the above description, the printable file means a file which is created in accordance with conditions set in advance based on configurational specifications of the printer 100. Specifically, the printable file has the print image with the resolution or the size which is suitable for the configurational specifications (print resolution, a size of a set printing medium, or the like) of the printer 100.

It is preferable that the icons A1 to A9 are formed of graphics which are useful for a user to intuitively determine the types.

### Operation History Display Screen

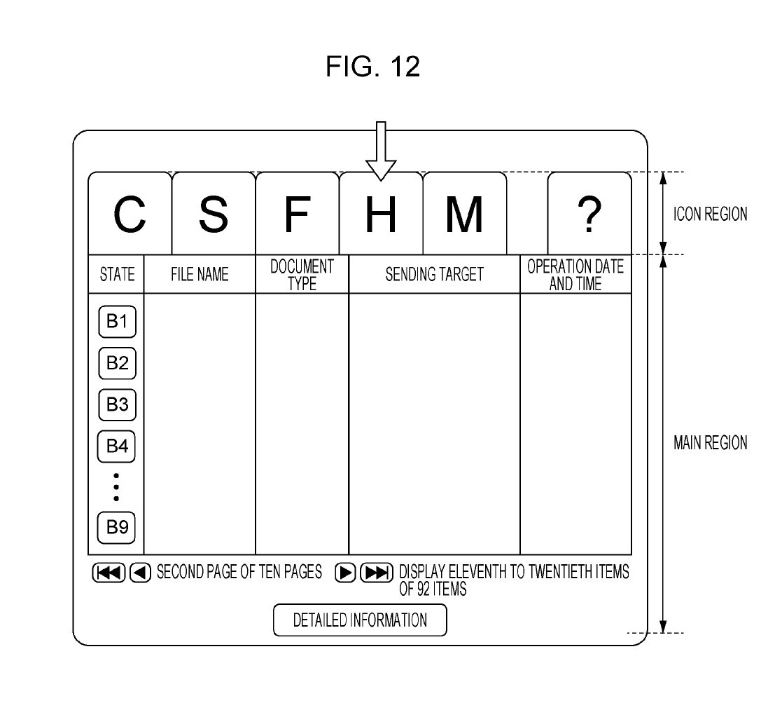

FIG. 12 is a conceptual diagram of a screen (hereinafter, referred to as an operation history display screen) which is displayed in a case where an operation history display “H” in the icon region is selected.

In the main region on the operation history display screen, a list of a history of file operations is displayed as a selectable file list. Items to be displayed include an icon of a state of a file (state), file name, document type, destination email address in a case of sending email or destination folder name in a case of being saved in a shared folder, IP address of a personal computer to be downloaded to (recipient), operated date and time, and the like.

In addition, since a list of the files may fill a plurality of pages in some cases, there are buttons of next page and previous page or a section in which information on a displayed page is displayed.

In addition, on the operation history display screen, there is a button which enables detailed display to be executed with respect to a file selected from the list of files.

Icons to be displayed in a column of state represent information based on operation history of a file and the corresponding icons (B1 to B7) are displayed based on a print history, a sending and forwarding history, or the like. In addition, the icons are not displayed for a file which is not relevant to the icons (B1 to B7).

The icons (B1 to B7) are, for example, as follows. Types of icons are not limited thereto and any icon may be adopted as long as the icon is easy to select or recognize in a case where a user selects a target file according to the operation history. The icons include B1: printed file; B2: file of which printing is cancelled; B3: file sent by email; B4: file of which email sending is cancelled; B5: file forwarded to a shared folder; B6: file of which forwarding to a shared folder is cancelled; and B7: downloaded file.

It is preferable that the icons B1 to B7 are formed of graphics which are useful for a user to intuitively determine the states.

### Detailed Information Screen

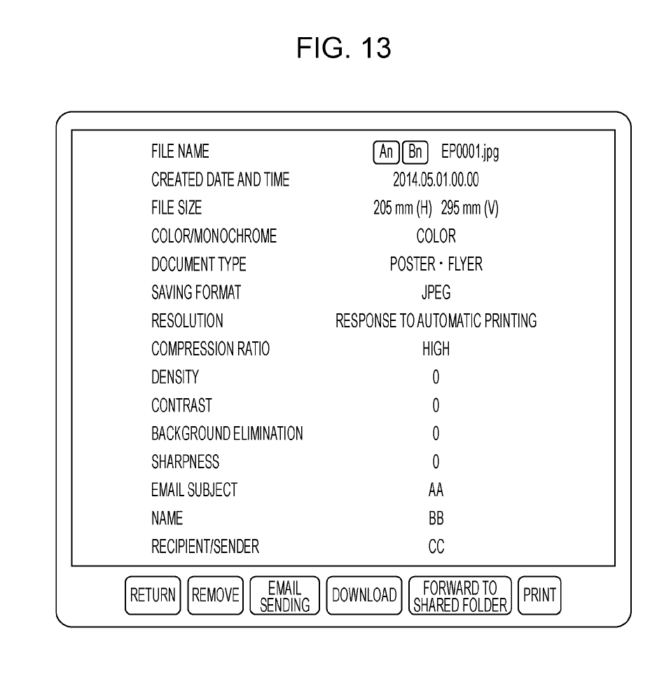

FIG. 13 is a conceptual diagram of a screen (hereinafter, referred to as a detailed information screen) which is displayed in a case where a file is selected on the file operation screen (FIG. 11) or on the operation history display screen (FIG. 12) and a detailed information button is pressed.

For example, the following information is displayed on the detailed information screen.

The information includes the icons (A1 to A9 and B1 to B7) representing the print attribute information described above and file name (file name), file creation date and time (creation date and time), length and width of the original document 2 (file size), color or monochrome of the original document at the time of scanning (color/monochrome), an original document type at the time of scanning, saving format of a file (saving format), resolution of a print image (resolution), a compression ratio of a file (compression ratio), a value of density at the time of scanning (density), a value of contrast at the time of scanning (contrast), a value of background elimination at the time of scanning (background elimination), a value of sharpness at the time of scanning (sharpness), a subject of a received email (email subject), a name of an address of an email sender or an email recipient or a name of a forwarding destination folder (name), an address of an email sender or an email recipient or a forwarding destination folder (recipient/sender).

In addition, buttons to execute, for example, printing a selected file, email sending, downloading, forwarding to a shared folder, removing, and the like are displayed.

Descriptions of a setting registration screen and a help information display screen are omitted.

As described above, it is possible to achieve the following effects in the printing apparatus (printer 100) according to the present embodiment.

The printer 100 includes the HDD unit 210. In addition, in the tablet terminal 90 on which the file list screen is displayed and a file stored in the HDD unit 210 can be selected on the file list screen, the print attribute information based on attributes related to printing of the file is displayed on the file list screen. Therefore, it is possible for a user of the printer 100 to cause the file to be stored in the printer 100 and to be printed. In addition, it is possible for the list of the stored files to be viewed. The print attribute information, from which suitability of the file for printing is determinable, is displayed on the file list screen. Therefore, when an image included in the file is printed, it is possible for the user to determine the suitability of printing only by viewing the file list screen.

In addition, since the print attribute information is displayed on the icons, it is possible for the user to more easily determine the suitability of printing only by viewing the file list screen.

In addition, since the resolution of the print image based on the file is included in the attributes related to the printing of the file, it is possible for the user to more easily determine the suitability of printing only by viewing the file list screen. Specifically, it is possible to speculate or identify print quality even without actually performing the printing, to determine compatibility with print characteristics (print resolution) of the printer 100, and to estimate time to be taken for printing.

In addition, since the print history of the print image based on the file is included in the attributes related to the printing of the file, it is possible for the user to more easily select a print target file only by viewing the file list screen when the image is printed based on the file. Specifically, it is possible to simply perform a determination, in a case of selection of a file of which printing has been performed or in a case of selection of a file of which printing has not been performed.

In addition, since a size of the print image based on the file is included in the attributes related to the printing of the file, it is possible for the user to determine the suitability of printing only by viewing the file list screen. Specifically, it is possible to perform the setting of the printer 100 or to easily determine suitability of the printing medium (paper roll 1) set in the printer 100 or for the time which is taken for the printing to be estimated.

The above description is provided based on a screen displayed on the tablet terminal 90 and the same operation may be performed on the operation panel 60. Since the operation panel 60 is connected to the controller 50 without the network 9, the same screen (screen described in FIGS. 5A and 5B or in FIGS. 6A and 6B) as the screen accessed by the tablet terminal 90 using a Web browser is displayed at a stage at which the printer 100 is supplied with power. The other operation screen is the same as in the case of the tablet terminal 90.

The entire disclosure of Japanese Patent Application No. 2014-110949, filed May 29, 2014 and 2015-088165, Apr. 23, 2015 are expressly incorporated by reference herein.

What is claimed is:

1. A printing apparatus comprising:
a storage device; and
a display section that displays a file list screen on which a file stored in the storage device is selectable,
wherein print attribute information, from which suitability of the file for printing is determinable, is displayed on the file list screen.

2. The printing apparatus according to claim 1,
wherein the print attribute information is displayed as an icon.

3. The printing apparatus according to claim 1,
wherein the print attribute information includes a resolution information of a print image in the file.

4. The printing apparatus according to claim 1,
wherein the print attribute information includes a print history information of the file.

5. The printing apparatus according to claim 1,
wherein the print attribute information includes a size information of a print image included in the file.

6. A printing apparatus comprising:
a connecting section to which a display terminal is connectable; and
a storage device,
wherein, in the display terminal that displays a file list screen on which a file stored in the storage device is selectable, print attribute information from which suitability of the file for printing is determinable is displayed on the file list screen.

7. The printing apparatus according to claim 6,
wherein the print attribute information is displayed as an icon.

8. The printing apparatus according to claim 6,
wherein the print attribute information includes a resolution information of a print image included in the file.

9. The printing apparatus according to claim 6,
wherein the print attribute information includes a print history information of the file.

10. The printing apparatus according to claim 6,
wherein the print attribute information includes a size information of a print image in the file.
